(19) United States
(12) Patent Application Publication
(10) Pub. No.: US 2010/0125616 A1
(43) Pub. Date: May 20, 2010

(54) AUTOMATIC GENERATION OF DOCUMENT TRANSLATION MAPS

(75) Inventor: Jared Michael Groth, Ypsilanti, MI (US)

Correspondence Address: AT&T Legal Department - JW;Attn: Patent Docketing, Room 2A-207, One AT&T Way, Bedminster, NJ, 07921, US

(73) Assignee: STERLING COMMERCE, INC., Dublin, OH (US)

(21) Appl. No.: 12/274,254

(22) Filed: Nov. 19, 2008

(51) Int. Cl. G06F 17/30; G06F 15/16; G07F 19/00

(52) U.S. Cl. 707/804; 709/204; 705/34; 707/E17.009

(57) ABSTRACT

A method for generating translation maps for converting electronic documents is disclosed. Machine-interpretable encodings of respective source and target documents are used to automatically generate the translation map. Generating the machine-interpretable encodings may involve using semantic analysis to create semantic descriptions of the document formats. The translation map may be cached. The source document is converted to the target document using the translation map. The translation map or the target document may be delivered to a second entity by a first entity. If some portion of the source document is not converted, indication of the unconverted sections may be reported.

### BACKGROUND

1. Field of the Disclosure

The present disclosure relates to document translation and, more particularly, the automatic generation of translation maps.

2. Description of the Related Art

Documents, especially business documents such as purchase orders, invoices, and so forth, may be exchanged electronically between two enterprises. Enterprises may develop unique formats for their internal business documents. When two such enterprises wish to exchange business documents electronically, they may agree to do so by converting documents from their respective internal formats to a standardized format such as an electronic data interchange (EDI) format.

### BRIEF DESCRIPTION OF THE DRAWINGS

FIG. 1 is a block diagram of selected elements of an embodiment of a document translation or conversion process;

FIG. 2 is a block diagram of selected elements of an embodiment of a document translation process;

FIG. 3 is a block diagram of selected elements of an embodiment of a document translation process;

FIG. 4 is a block diagram of selected elements of an embodiment of a map generation process;

FIG. 5 is a block diagram of selected elements of an embodiment of an encoding process;

FIG. 6 illustrates an embodiment of a method for document translation;

FIG. 7 illustrates an embodiment of a method for document translation; and

FIG. 8 is a block diagram of selected elements of an embodiment of a computing device.

### DESCRIPTION OF THE EMBODIMENT(S)

In one aspect, a disclosed method exchanging electronic documents between a first entity and a second entity includes accessing a first machine-readable encoding defining a first document format, the first document format being associated with the first entity, and accessing a second machine-readable encoding defining a second document format, the second document format being associated with the second entity. The method may further include using the first and second machine-readable encodings to automatically generate a mapping for converting a first electronic document, compliant with the first document format, to a second electronic document, compliant with the second document format. The generated mapping may then be output to an external processing device.

In some embodiments, semantic descriptions may be used to automatically generate the mapping, such that the first and second machine-readable encodings are indicative of semantic descriptions of the respective document formats. The method may further include generating the first and second machine-readable encodings. In some cases, semantic analysis may be used to generate the encodings. The encodings may comply with a vocabulary description language. The vocabulary description language may be the Resource Description Framework Schema (RDFS).

The method may further include using user input to generate the first and second machine-readable encodings, and displaying the first and second machine-readable encodings on a display device. Still further, the method may include translating the first electronic document to the second electronic document using the generated mapping, and delivering the second electronic document in the second format to the second entity. The second entity may process the document without additional translation. The translating may be directly performed without creating a document in a third, intermediate format. In some embodiments, neither the first nor the second document format is an EDI format. The first electronic document may be of various types, including an offer for purchase, a purchase order, an invoice, an order confirmation, a billing statement, a shipping notification or an account statement.

In another aspect, a disclosed service for converting business documents includes deciphering a first machine-readable interpretation of a first business document, the first business document being compliant with a first document format, and deciphering a second machine-readable interpretation of a second business document, the second business document being compliant with the second document format. The service may also include automatically generating a conversion map for converting business documents from the first document format to the second document format based on the first and second machine-readable interpretations. The conversion map may then be stored on a storage device.

In some instances, the first document format is associated with a first entity, and the second document format is associated with a second entity. In some embodiments, the service further includes enabling the first entity to invoke the conversion map to convert the first business document to the second document format. In some cases, the method includes converting the first business document to the second business document using the conversion map, and electronically delivering the second business document to the second entity. In some embodiments, portions of the first business document are not be converted by the conversion map to the second document format. In these embodiments, the service may further include displaying to the second entity an indication of any portion of the first business document that was not converted.

In some instances, the service includes displaying to the first entity an indication that the conversion map has been automatically generated. The first and second machine-readable interpretations may be respective first and second semantic descriptions of the respective first and second document formats, such that the service further includes generating semantic descriptions of the first and second document formats.

In still another aspect, a disclosed computer-readable memory media includes processor executable instructions for generating mapping modules for electronic document translation. The memory media instructions may be executable to construe a machine-interpretable representation of a first format for an electronic document, construe a machine-interpretable representation of a second format for the electronic document, generate a mapping module usable to translate a document having the first format to a document having the second format, and invoke the mapping module to output to a user the translated document having the second format.

In some instances, the first format and the second format may be respectively specific to a first entity and a second entity, and the electronic documents may be business documents. In some cases, the memory media includes instructions executable to deliver the translated document to the second entity. In some instances, the memory media instructions are executable to deliver the mapping module to the second entity. In some embodiments, the memory media instructions are executable to cache a copy of the mapping module, and retrieve the cached copy of the mapping module.

In yet another aspect, a disclosed device for converting electronic documents includes a processor and memory media, accessible to the processor, including processor executable instructions. The instructions may be executable to interpret a first computer-readable encoding of a first format for an electronic document, and interpret a second computer-readable encoding of a second format for the electronic document. The first and second computer-readable encodings may be used to generate a conversion map usable to convert a source document complying with the first format to a target document complying with the second format. The conversion map may be invoked to output the target document. In some embodiments, the instructions executable to invoke the conversion map may include instructions executable to output the target document directly, without using a converted document in a third, intermediate format.

In the following description, details are set forth by way of example to facilitate discussion of the disclosed subject matter. It should be apparent to a person of ordinary skill in the field, however, that the disclosed embodiments are exemplary and not exhaustive of all possible embodiments.

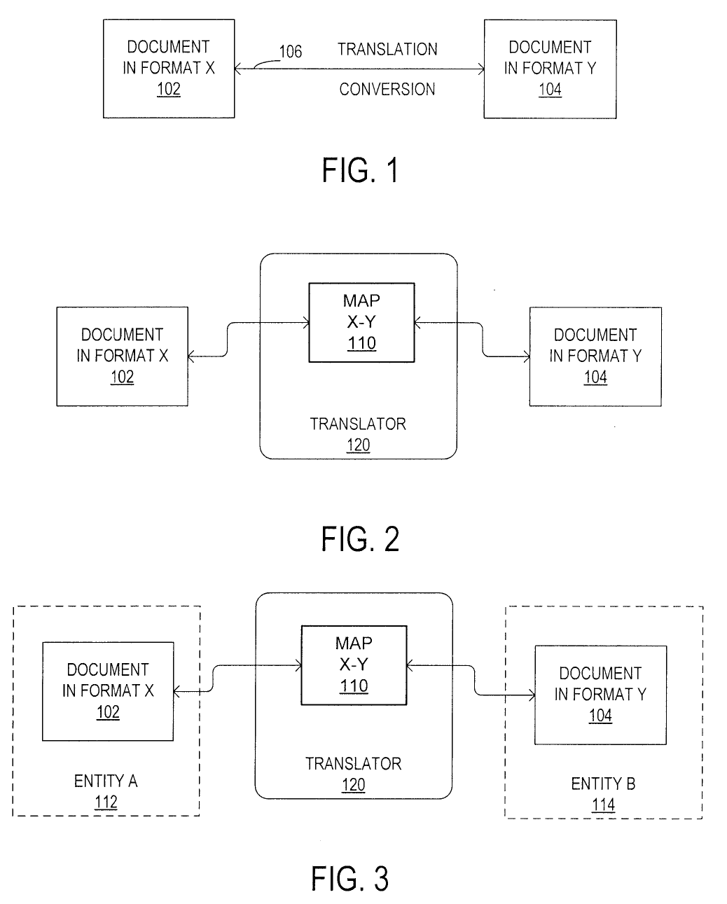

Turning now to the drawings, FIG. 1 is a block diagram illustrating selected elements of an embodiment of a document translation or conversion process. In one embodiment, a document 102 in one format, referred to herein as format X, may be translated or converted by process 106 into a document 104 in another format, referred to herein as format Y. As used herein, the term “document” and “electronic document” are interchangeable.

As used herein, the term “format” describes the way information is encoded into a document and also determines how and by whom a document may be read. Examples of formats for electronic documents include Extensible Markup Language (XML) format, Electronic Data Interchange (EDI) format, machine-readable coding, and application-specific formats including combinations of formatted elements. Thus, a format describes how a document is constructed and what information is included in the document. The format further provides a description for an application that reads or writes the document. In some embodiments of process 106, individual data elements within documents, such as data fields, are interpreted and reformatted.

In business systems, a particular document format may be specific, or proprietary, to a given business entity. For example, a company may accept documents in a certain format for processing by their own database system. In an exemplary supply chain, vendors and clients regularly exchange electronic documents, such as an offer for purchase, a purchase order, an invoice, an order confirmation, a billing statement, a shipping notification, an account statement, etc. Such types of documents may exist in different formats within the data processing systems of their respective business entities, even though the information contained in documents complying with different formats is comparable. The conversion, or translation, between different document formats may thus facilitate the exchange of electronic documents. One common industry standard for document transmission between business entities is EDI.

Formats X and Y, as shown in FIGS. 1-4 and mentioned herein, are arbitrary and represent different document formats. Process 106 shown in FIG. 1, which may be performed from formats X to Y or Y to X, represents the conversion of documents between different formats, also referred to herein as “translation”. The originating, or input, document, whose contents are read in process 106, is referred to as the “source” document. The resulting, or output, document, whose contents are written in process 106, is referred to as the “target” document. In other words, process 106, while generating a target document, may be bidirectional with respect to source and target documents. It is noted that generating a target document in process 106 may involve replacing an existing document or creating a new document. For clarity in the following discussion, it shall be assumed that format X is the source document format, and format Y is the target document format, although in different embodiments of the methods and systems disclosed herein, it is well understood that this arrangement is reversed, such that a bidirectional translation may be performed.

Turning now to FIG. 2, a block diagram illustrating selected elements of an embodiment of a document translation process is shown. In FIG. 2, source document 102 in format X is translated into target document 104 in format Y. A translator 120 uses a translation map 110 to perform the translation. The translation map 110 includes a representation of the information contained in formats X and Y, and how that information is correlated between formats X and Y. Examples of information included in translation map 110 are individual data elements within documents, such as data fields. In different embodiments, translation map 110 may be unidirectional (X to Y or Y to X) or bidirectional (X to Y and Y to X). In some cases, translation map 110 is specific to formats X and Y and is generated using information describing formats X and Y. In some embodiments, the format of translation map 110 itself is, in turn, specific to translator 120 (i.e., the application performing the translation).

Referring now to FIG. 3, a block diagram illustrating selected elements of an embodiment of a document translation process is shown. In one embodiment, source document 102 in format X is translated into target document 104 in format Y. A translator 120 uses a translation map 110 to perform the translation. The source document 102 is shown in FIG. 3 being associated with entity A 112, while target document 104 is associated with entity B 114. As discussed above with respect to FIG. 1, entity A 112 and entity B 114 may be different business entities, respectively associated with format X and format Y. In some embodiments, either format X or format Y may be proprietary formats respectively associated with the data processing systems of entity A 112 and entity B 114.

In certain embodiments of the process depicted in FIG. 3, portions of the process may be divided between entity A 112 and entity B 114. For example, in some cases, entity A 112 may perform the document conversion, and thereby include translator 120, such that entity B 114 is provided with the translated target document. In other cases, entity A 112 may provide entity B 114 with the translation map 110, which entity B 114 uses to perform the translation using translator 120. In still other embodiments, translator 120 is associated with a third-party providing services to both entity A 112 and entity B 114.

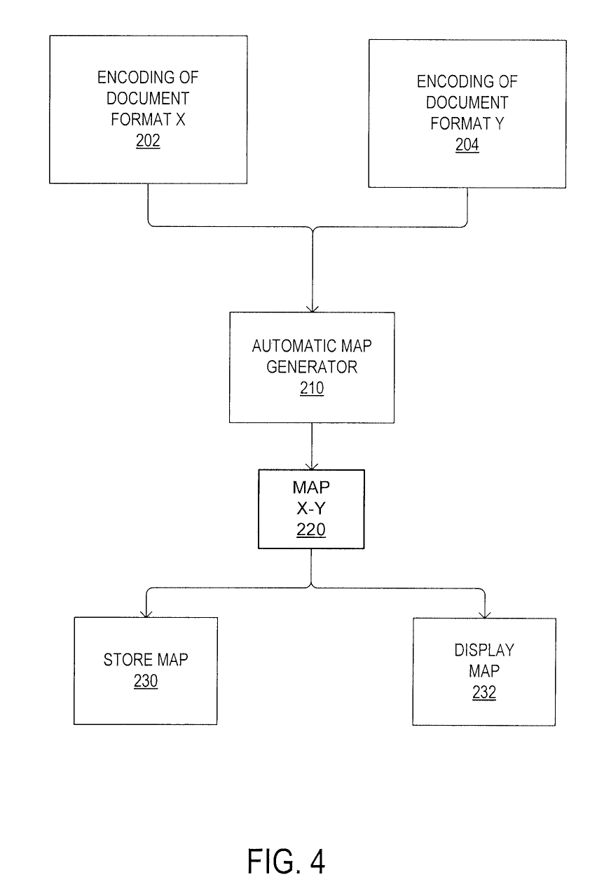

Turning now to FIG. 4, a block diagram of selected elements of an embodiment of a map generation process is shown. In FIG. 4, encoding 202 of document format X and encoding 204 of document format Y are accessed by automatic map generator 210. As used herein, “encoding” refers to data that is capable of being read and interpreted by a machine, and may include executable instructions. Examples of encodings include compiled or interpreted program instructions executable by a processor.

Encoding 202 and encoding 204 may be semantic encodings generated by a semantic analysis of format X and format Y, respectively. Thus, encoding 202 and encoding 204 include information that describes format X and format Y, respectively. In some embodiments, encoding 202 and encoding 204 are generated in Extensible Markup Language (XML) format. In certain embodiments, encoding 202 and encoding 204 comply with a vocabulary description language, such as the RDFS.

Encoding 202 and encoding 204 contain information about format X and format Y, respectively, such that automatic map generator 210 may use encoding 202 and encoding 204 to generate translation map 220 for translating documents between formats X and Y. In certain cases, the process illustrated in FIG. 4 is “automatic” in that no further user input is applied to generate translation map 220, once encoding 202 and encoding 204 have been provided and automatic map generator 210 has been initiated. Since, as noted above, format X and format Y are arbitrary, the process of FIG. 4 may be used to automatically generate translation map 220 for any number of arbitrary formats, once encoding 202 and encoding 204 are available.

It is noted that translation map 220 is usable as translation map 110 shown in FIG. 1. In some embodiments, translation map 220 is a mapping module that is accessible locally, or remotely via a network. Translation map 220 may also be implemented as a service provided by a third-party. In some cases, translation map 220 is delivered as computer-readable memory media including processor executable instructions. Examples of computer-readable memory media include recordable type media such as floppy disks, hard disk drives, CD ROMs, DVDs, solid-state memory devices, optical memory devices, organic memory devices, liquid memory devices, magnetic memory devices, and q-bit memory devices. In certain instances, translation map 220 is provided as a device for enabling document conversion, comprising a processor and memory accessible by the processor.

In operation 230, translation map 220 is stored on a storage device. A storage device may cache translation map 220, such that, once generated, access to translation map 220 is provided from the storage device. Translation map 220 may itself be a document in an electronic format. In some embodiments, translation map 220 is an XML document. In operation 232, translation map 220 may be displayed to a user on a display device or in hardcopy form.

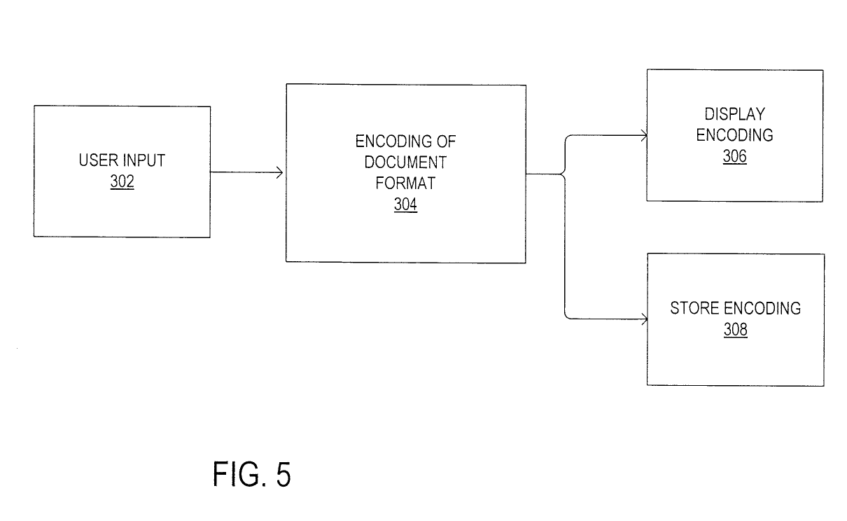

Referring now to FIG. 5, a block diagram of selected elements of an embodiment of an encoding process is shown. The process depicted in FIG. 5 is usable to generate an encoding of a document format usable by automatic map generator 210, such as encoding 202 and encoding 204, shown in FIG. 2. In the depicted embodiment, user input is provided (operation 302) for the document format. In some cases, user input is provided using an instance of the document complying with the document format (operation 302) A machine-readable encoding of the document format is generated (operation 304) using the user input provided in operation 302. As noted above with respect to FIG. 2, operations 302 and 304 may be performed using semantic analysis to generate a semantic encoding of the document format. The encoding may be displayed (operation 306) to a user on a display device or in hardcopy form. The encoding may be stored (operation 308) on a storage device, which may be made accessible to automatic map generator 210 (see FIG. 2).

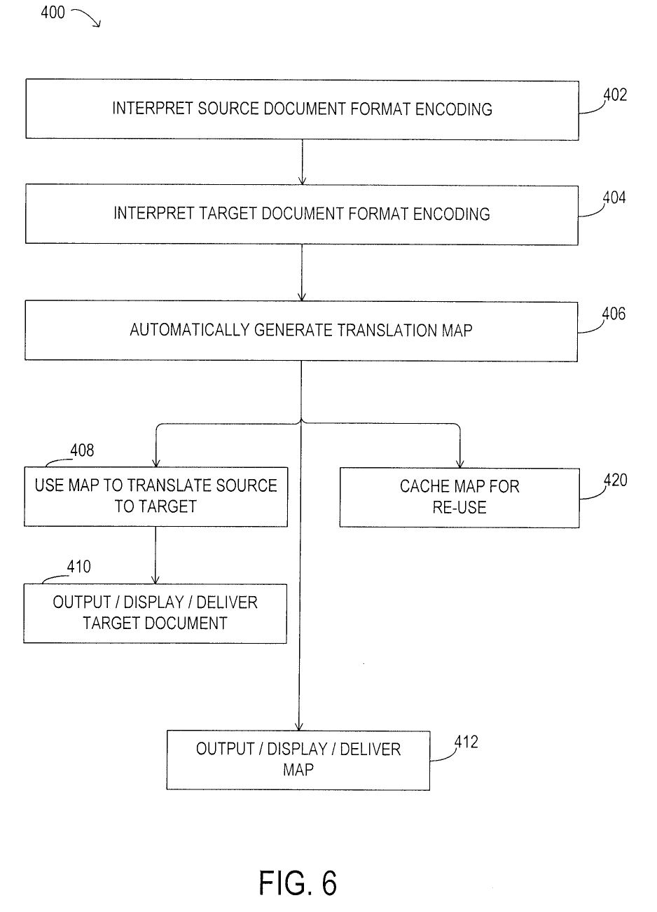

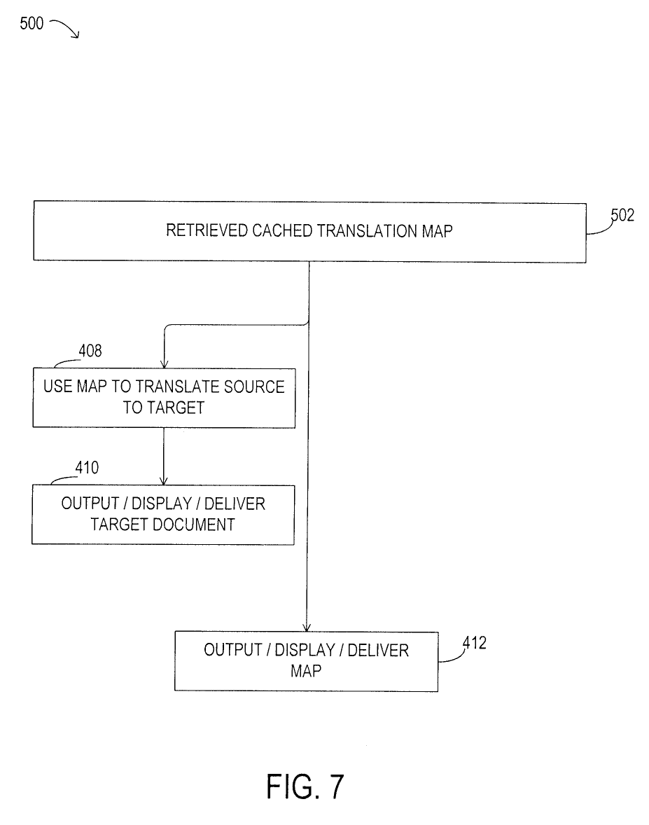

Referring now to FIG. 6, a flow-chart depicting one embodiment of a method 400 for document translation is shown. The encoding of the source document format is obtained and interpreted (operation 402). Further, the encoding of the target document format is obtained and interpreted (operation 404). In some embodiments, the encoding is machine-readable and machine-interpretable, such that operations 402 and 404 may be performed automatically, that is, without relying on user input once initiated. In other embodiments, operations 402 and 404 may require additional input in order to interpret the document format. The interpretations from operation 402 and operation 404 are used (operation 406) to generate a translation map for the source and target formats. The translation map is cached (operation 420) for re-use (see also FIG. 7). The translation map is used to translate (operation 408) a source document to a target document (i.e., convert a document in the source format to a document in the target format). The target document is generated (operation 410) as output (i.e., stored on a storage device), displayed to a user, or delivered to a business entity. In some embodiments, operation 410 includes transmitting the target document over a communications network. In some instances, the translation map itself may be output, displayed to a user, or delivered to a business entity (operation 412). In some embodiments, operation 410 and/or operation 412 involve a commercial transaction.

Referring now to FIG. 7, a flow-chart depicting one embodiment of a method 500 for document translation is shown. A cached translation map is retrieved (operation 502). In operations 408, 410 and 412, the translation map is used in the same manner as discussed above for like elements with respect to FIG. 4.

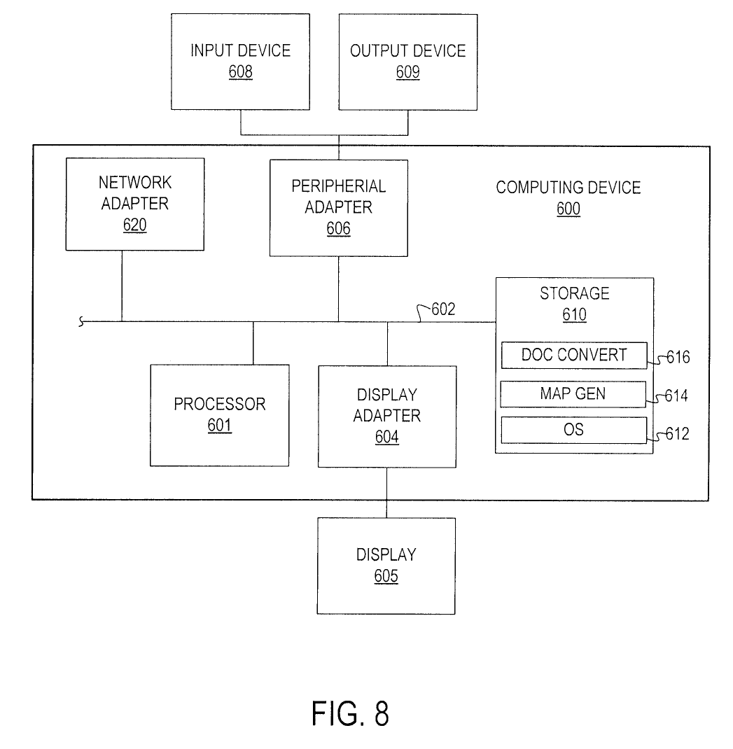

Referring now to FIG. 8, a block diagram illustrating selected elements of an embodiment of a computing device 600 is presented. In the embodiment depicted in FIG. 8, device 600 includes processor 601 coupled via shared bus 602 to storage media collectively identified as storage 610.

Device 600, as depicted in FIG. 8, further includes network adapter 620 that interfaces device 600 to a network (not shown in FIG. 8). In embodiments suitable for use in document translation, device 600, as depicted in FIG. 8, may include peripheral adapter 606, which provides connectivity for the use of input device 608 and output device 609. Input device 608 represents user input devices, such as a keyboard, mouse, trackball, touch panel, microphone, video camera, etc. Output device 609 represents input or output devices for sound, video, or images, such as speakers, microphones, headphones, projector displays, etc.

Device 600 is shown in FIG. 8 including display adapter 604 and further includes a display device or, more simply, a display 605. Display adapter 604 may interface shared bus 602, or another bus, with an output port for one or more displays, such as display 605. Display 605 may be implemented as a liquid crystal display screen, a computer monitor, a television or the like. Display 605 may comply with a display standard for the corresponding type of display. Standards for computer monitors include analog standards such as VGA, XGA, etc., or digital standards such as DVI, HDMI, among others. A television display may comply with standards such as NTSC (National Television System Committee), PAL (Phase Alternating Line), or another suitable standard. Display 605 may include an output device 609, such as one or more integrated speakers to play audio content, or may include an input device 608, such as a microphone or video camera.

Storage 610 encompasses persistent and volatile media, fixed and removable media, and magnetic and semiconductor media. Storage 610 is operable to store instructions, data, or both. Storage 610 as shown includes sets or sequences of instructions, namely, an operating system 612 a map generation application program identified as 614, and a document conversion application 616. Operating system 612 may be a UNIX or UNIX-like operating system, a Windows® family operating system, or another suitable operating system.

In some embodiments, storage 610 is configured to store and provide executable instructions for performing document conversion, as mentioned previously. In some instances, storage 610 is configured to cache translation maps for re-use, comparable to operation 420 in FIG. 6, and retrieve translation maps, as in operation 502 shown in FIG. 7. As shown in FIG. 8, device 600 is configured to execute instructions for generating translation maps using map generation application 614, analogous to the process depicted in FIG. 4 and operation 406 of FIG. 6. In some embodiments, device 600 is configured to execute instructions for document conversion using document conversion application 616, analogous to the processes depicted in FIGS. 1-3 and operation 408 in FIGS. 6-7.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for exchanging electronic documents between a first entity and a second entity, comprising:
accessing a first machine-readable encoding defining a first format, the first format being associated with the first entity;
accessing a second machine-readable encoding defining a second format, the second format being associated with the second entity;
using the first and second machine-readable encodings to automatically generate a mapping for converting a first electronic document, compliant with the first format, to a second electronic document, compliant with the second format; and
outputting the generated mapping to an external processing device.

2. The method of claim 1, wherein the first and second machine-readable encodings are indicative of semantic descriptions of the respective formats and wherein said using includes using the semantic descriptions.

3. The method of claim 1, further comprising:
generating the first and second machine-readable encodings.

4. The method of claim 3, wherein said generating uses semantic analysis.

5. The method of claim 3, wherein the first and second machine-readable encodings comply with a vocabulary description language.

6. The method of claim 5, wherein the vocabulary description language is the Resource Description Framework Schema.

7. The method of claim 1, wherein the first and second machine-readable encodings comply with XML-format and wherein the first and second machine-readable encodings are generated using user input respectively associated with the first and second formats.

8. The method of claim 1, further comprising:
using user input to generate the first and second machine-readable encodings; and
displaying the first and second machine-readable encodings on a display device.

9. The method of claim 1, further comprising:
translating the first electronic document to the second electronic document using the generated mapping; and
delivering the second electronic document in the second format to the second entity, wherein the second entity processes the document without additional translation.

10. The method of claim 9, wherein said translating is directly performed without creating a document in a third, intermediate format.

11. The method of claim 1, further comprising:
storing the generated mapping; and
displaying the generated mapping on a display device.

12. The method of claim 1, wherein neither the first nor the second format is an EDI format.

13. The method of claim 1, wherein the first electronic document is a type of document selected from a list of document types consisting of: an offer for purchase, a purchase order, an invoice, an order confirmation, a billing statement, a shipping notification, and an account statement.

14. A service for converting business documents, comprising:
deciphering a first machine-readable interpretation of a first business document, the first business document being compliant with a first document format;
deciphering a second machine-readable interpretation of a second business document, the second business document being compliant with the second document format;
automatically generating a conversion map for converting business documents from the first document format to the second document format based on the first and second machine-readable interpretations; and
storing the conversion map on a storage device.

15. The service of claim 14, wherein the first document format is associated with a first entity, and wherein the second document format is associated with a second entity.

16. The service of claim 15, further comprising:
enabling the first entity to invoke the conversion map to convert the first business document to the second document format.

17. The service of claim 15, further comprising:
converting the first business document to the second business document using the conversion map; and
electronically delivering the second business document to the second entity.

18. The service of claim 15, wherein at least some portion of the first business document is not converted by the conversion map to the second document format, and further comprising:
displaying to the second entity an indication of the portion of the first business document that was not converted.

19. The service of claim 14, further comprising:
displaying to the first entity an indication that the conversion map has been automatically generated.

20. The service of claim 14, wherein said first and second machine-readable interpretations are respective first and second semantic descriptions of the respective first and second document formats, and further comprising:
generating semantic descriptions of the first and second document formats.

21. Computer-readable memory media, including processor instructions for generating mapping modules for electronic document translation, executable to:
construe a machine-interpretable representation of a first format for an electronic document;
construe a machine-interpretable representation of a second format for the electronic document;
generate a mapping module usable to translate a document having the first format to a document having the second format; and
invoke the mapping module to output the translated document having the second format.

22. The memory media of claim 21, wherein the first and second formats are respectively specific to a first and second entity, and wherein the electronic documents are business documents.

23. The memory media of claim 22, further including instructions executable to:
deliver the document having the second format to the second entity.

24. The memory media of claim 22, further including instructions executable to:
deliver the mapping module to the second entity.

25. The memory media of claim 22, further including instructions executable to:
cache a copy of the mapping module,
wherein said instructions executable to invoke the mapping module include instructions executable to retrieve the cached copy of the mapping module.

26. A device for converting electronic documents, comprising:
a processor;
memory media accessible to the processor, including processor executable instructions to:
interpret a first computer-readable encoding of a first format for an electronic document;
interpret a second computer-readable encoding of a second format for the electronic document;
use the first and second computer-readable encodings to generate a conversion map usable to convert a source document complying with the first format to a target document complying with the second format; and
invoke the conversion map to output the target document,
wherein the first and second formats are respectively specific to a first and second business entity.

27. The device of claim 27, wherein at least some portion of the source document is not converted by the conversion map to the second format, and further comprising instructions executable to:
generate an indication of the portion of the source document that was not converted.

28. The device of claim 27, further including instructions executable to:
cache a copy of the conversion map,
wherein said instructions executable to invoke the conversion map include instructions executable to retrieve the cached copy of the conversion map.

29. The device of claim 27, wherein said instructions executable to invoke the conversion map include instructions executable to output the target document directly without using a converted document in a third, intermediate format.
